(19) United States
(12) Patent Application Publication
(10) Pub. No.: US 2013/0346396 A1
(43) Pub. Date: Dec. 26, 2013

(54) AUTOMATICALLY UPDATING A QUERY

(71) Applicant: Google Inc., Mountain View, CA (US)

(72) Inventors: Tom C. Stamm, Louisville, CO (US); Tushar Udeshi, Broomfield, CO (US); James A. Guggemos, Windsor, CO (US); Gokay Baris Guttekin, Palo Alto, CA (US)

(21) Appl. No.: 13/940,466

(22) Filed: Jul. 12, 2013

Related U.S. Application Data
(63) Continuation of application No. PCT/US2013/047176, filed on Jun. 21, 2013.
(60) Provisional application No. 61/662,949, filed on Jun. 22, 2012.
(60) Provisional application No. 61/663,764, filed on Jun. 25, 2012.

(51) Int. Cl. G06F 17/30

(52) U.S. Cl. CPC G06F 17/30554
USPC 707/722

(57) ABSTRACT

A computing system is described that can update a query on behalf of a user. In some embodiments, the user's internet search history can be stored and processed by a server to identify one or more user interest queries. For example, queries that are specific enough to trigger the display of an inline result can be identified as a user interest query. The server can maintain a profile for the user that includes the user interest queries. Later on, the user's context can be received by the server. This can include the user's current location and/or the local time at that location. User interest queries determined to be relevant to the user's context can be updated, and the results can be automatically provided to the user. The user can thus be provided with relevant, updated information without having to manually repeat a past query.

This is a Continuation of Application Serial No. PCT/US2013/47176, filed Jun. 21, 2013, which claims the benefit of U.S. Provisional Application No. 61/662,949, filed Jun. 22, 2012, and U.S. Provisional Application No. 61/663,764, filed Jun. 25, 2012, the entire contents of each of which are hereby incorporated by reference.

### BACKGROUND

A user may conduct queries using an Internet search engine for people, places, things, etc. that are of interest to the user. From the results of a query, the user is able to obtain information relating to the query that exists at the time the query is executed. As time passes, however, information relating to the query may change, or additional information relating to the query may be generated. In order to obtain changed or additional information, the user must manually repeat the query.

For example, the user can perform a query in the browser of their mobile device, leave the browser window active, and refresh it frequently or bookmark it. The user can also perform the query from their desktop computer, and then access their search history from their mobile device browser to re-run the query.

Both of these approaches are cumbersome and time-consuming for the user. The user must manually poll for updates, and if the user has several of these queries that they regularly perform, they are required to dig up the correct query each time.

### SUMMARY

Techniques are described for automatically updating a query on behalf of a user. In some examples, the user's Internet search history can be stored and processed by a server to identify one or more user interest queries. For example, queries that are specific enough to trigger the display of an inline search result can be identified as a user interest query. The server can maintain a profile for the user that includes the user interest queries. Later on, the user's context can be received by the server. This can include the user's current location and/or the local time at that location. User interest queries determined to be relevant to the user's context can be updated, and the results can be automatically provided to the user. The user can thus be provided with relevant, updated information without having to manually repeat a past query.

In one example, a method for automatically updating a query on behalf of a user is provided. The method includes retrieving a user's Internet search history from a memory, said search history comprising a plurality of queries previously entered by the user. The method also includes, using a processor coupled to the memory, identifying at least one of the plurality of queries as a user interest query, and receiving a current context of the user. The method also includes, using the processor, determining whether the user interest query is relevant to the user based on the user's context and automatically outputting an updated result of the user interest query when the user interest query is determined to be relevant.

A query can be identified as a user interest query if the query triggered an inline search result when the query was previously executed. A query can be identified as a user interest query if the query appears multiple times in the user's search history. A query that appears multiple times in the user's search history can be identified as an ongoing user interest query. The method can include automatically outputting results of the ongoing user interest query when updated results are available for said query. A query can be identified as a time-sensitive user interest query when the query is associated with an expiration time. The method can include automatically outputting results of the time-sensitive user interest query until the expiration time lapses. The user's context can include the user's current location and the local time at the user's current location. The user interest query can be determined to be relevant if a current result of the user interest query has changed since a previous result of the user interest query was output. The user interest query can be determined to be relevant if the query relates to an event that is scheduled to occur within a predetermined time from a current time of the user. Outputting an updated result can include sending the updated result to a mobile device of the user. Outputting an updated result can be performed in response to a request for relevant information received with the user's context.

In another example, a system for automatically updating a query on behalf of a user is provided that includes a processor and a memory having instructions stored thereon for execution by the processor. The instructions include a user profile module that retrieves a user's Internet search history from the memory, said search history comprising a plurality of queries previously entered by the user, and that identifies at least one of the plurality of queries as a user interest query. The instructions also include a context receiving module that receives a current context of the user, a relevancy processing module that determines whether the user interest query is relevant to the user based on the user's context, and an output module that automatically outputs an updated result of the user interest query when the user interest query is determined to be relevant.

The user profile module can identify a query as a user interest query if the query triggered an inline search result when the query was previously executed. The user profile module can identify a query as a user interest query if the query appears multiple times in the user's search history. The user profile module can identify a query that appears multiple times in the user's search history as an ongoing user interest query. The output module can automatically output results of the ongoing user interest query when updated results are available for said query. The user profile module can identify a query as a time-sensitive user interest query when the query is associated with an expiration time. The output module can automatically output results of the time-sensitive user interest query until the expiration time lapses. The user's context can include the user's current location and the local time at the user's current location. The relevancy processing module can determine that the user interest query is relevant if a current result of the user interest query has changed since a previous result of the user interest query was output. The relevancy processing module can determine that the user interest query is relevant if the query relates to an event that is scheduled to occur within a predetermined time from a current time of the user. The output module can send the updated result to a mobile device of the user. The output module can output the updated result in response to a request for relevant information received with the user's context.

In another example, a mobile device that automatically updates a query on behalf of a user is provided that includes a processor and a memory having instructions stored thereon for execution by the processor. The instructions include a user profile module that retrieves a user's Internet search history, said search history comprising a plurality of queries previously entered by the user, and that identifies at least one of the plurality of queries as a user interest query. The instructions also include a context determining module that determines a current context of the user, a relevancy processing module that determines whether the user interest query is relevant to the user based on the user's context, and a display module that automatically displays an updated result of the user interest query when the user interest query is determined to be relevant.

The details of one or more examples are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a schematic diagram of an example mobile network.

FIG. 2 is a schematic diagram of an example computer system.

FIG. 3A is a schematic diagram of an example query server.

FIG. 3B is a schematic diagram of a search result web page that includes a weather inline search result.

FIG. 3C is a schematic diagram of a search result web page that includes a sports team inline search result and a news inline search result.

FIG. 3D is a schematic diagram of a search result web page that includes a flight status inline search result.

FIG. 3E is a schematic diagram of a search result web page that includes only traditional search results.

FIG. 3F is a diagram of a graphical user interface that can be displayed on a mobile device.

FIG. 4 is a flowchart that schematically depicts example operations for maintaining a user profile.

FIG. 5 is a flowchart that schematically depicts example operations for automatically updating a query on behalf of a user.

FIG. 6 is a schematic diagram of an example mobile device.

### DETAILED DESCRIPTION

Techniques are described for automatically updating a query on behalf of a user. In some examples, the user's Internet search history can be stored and processed by a server to identify one or more user interest queries. For example, queries that are specific enough to trigger the display of an inline search result can be identified as a user interest query. The server can maintain a profile for the user that includes the user interest queries. Later on, the user's context can be received by the server. This can include the user's current location and/or the local time at that location. User interest queries determined to be relevant to the user's context can be updated, and the results can be automatically provided to the user. The user can thus be provided with relevant, updated information without having to manually repeat a past query.

Certain examples will now be described to provide an overall understanding of the principles of the structure, function, manufacture, and use of the described techniques. One or more examples of these examples are illustrated in the accompanying drawings. Those skilled in the art will understand that the described techniques are non-limiting examples and that the scope of the described techniques is defined solely by the claims. The features illustrated or described in connection with one example may be combined with the features of other examples. Such modifications and variations are intended to be included within the scope of the described techniques.

In situations discussed below in which systems and devices collect or make use of personal information about the user (e.g., search histories, location, etc.) the user may be provided with an opportunity to control whether programs or features of the systems and devices can collect user information (e.g., information about a user's e-mail, a user's social network, social actions or activities, profession, a user's preferences, user's Internet search history, a user's current location, etc.), or to control whether and/or how to the systems and devices may receive content that may be relevant to the user. In addition, certain data may be treated in one or more ways before it is stored or used by the systems and devices, so that personally identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the systems and devices described herein.

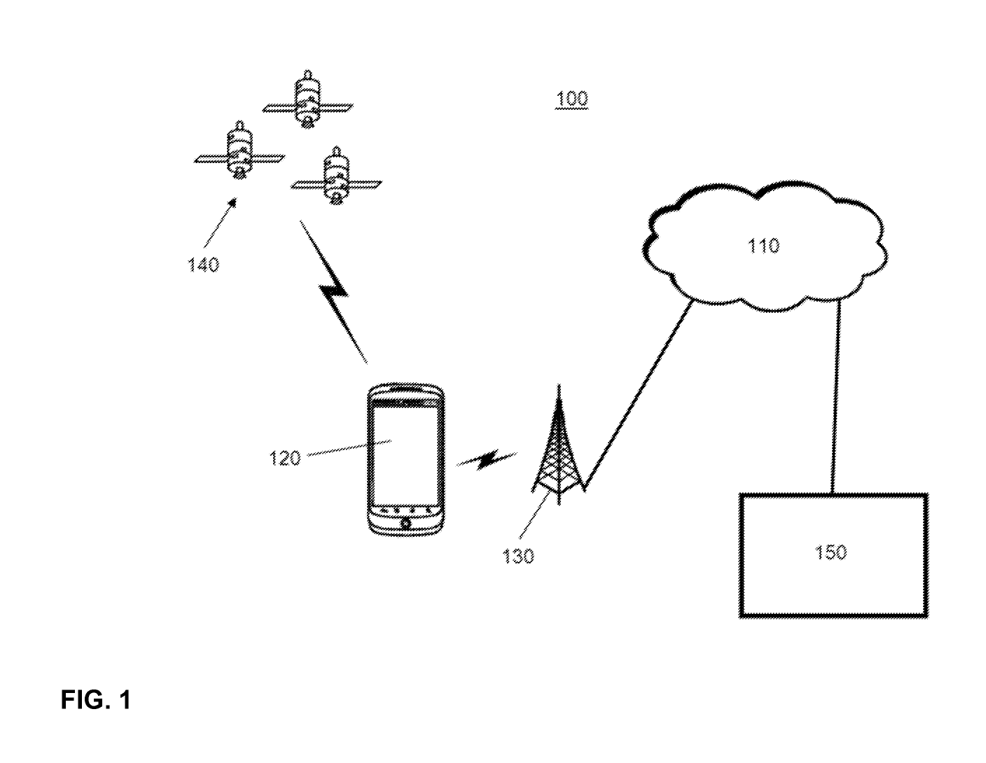

FIG. 1 illustrates an example mobile network 100 in which one or more of the described techniques can be implemented. The mobile network 100 includes a communications network 110 and a mobile device 120. The mobile device 120 can connect to the communications network 110 via various access points 130. Although one mobile device 120 and one access point 130 are illustrated for brevity, the mobile network 100 can include any number of mobile devices and access points.

The mobile device 120 can be or can include any computing device (also referred to herein as simply a “device”) that is configured to exchange data over the communications network 110, such as a mobile phone, tablet computer, laptop computer, and so forth. The mobile device 120 can also be or can include devices that are not necessarily “mobile,” such as desktop computers. The communications network 110 can include any of a variety of networks or combinations of networks, such as GSM, TDMA, CDMA, IEEE 802.11, Bluetooth, Wi-Fi, or any other wired or wireless networks. The access points 130 can be transceivers that provide a gateway between the mobile device 120 and the communications network 110. For example, the access points 130 can be wireless routers or cellular network towers. In some examples, the mobile device 120 can also receive Global Positioning System (GPS) signals transmitted from GPS satellites 140.

In the illustrated example, the mobile network 100 also includes a query server 150 that can exchange data with the mobile device 120 via the communications network 110. The query server 150 can be implemented on one or more computer systems (e.g., server computers, personal computers, workstations, mini-computers, clustered computer systems, or embedded computer systems). Some or all of the query server 150 functionality can also be implemented on the mobile device 120 itself.

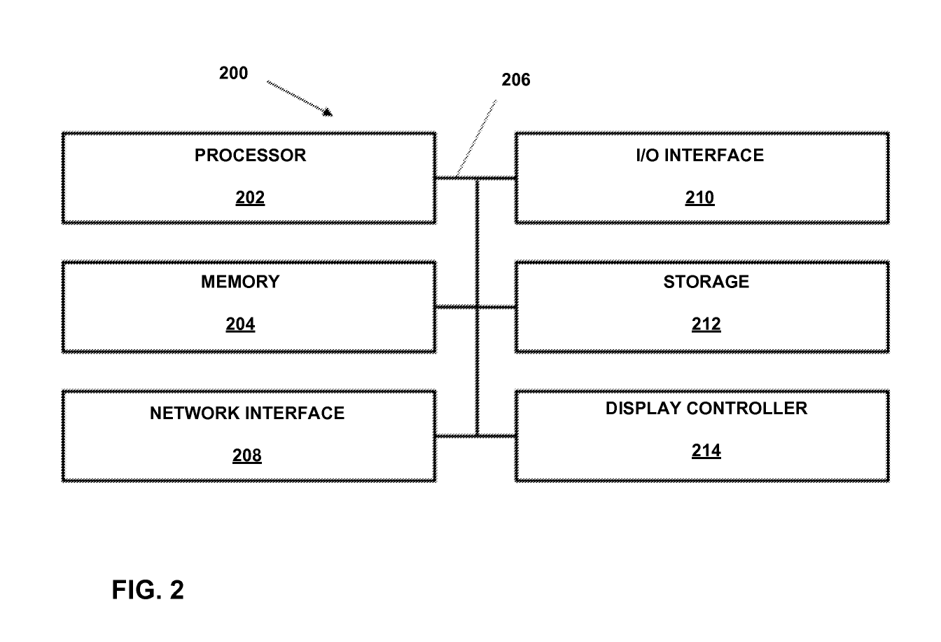

FIG. 2 illustrates an example computer system 200 which can be used to implement the mobile device 120 or the query server 150 of FIG. 1. Although computer system 200 is depicted and described herein, it will be appreciated that this is for sake of generality and convenience. In other examples, the computer system may differ in architecture and operation from that shown and described here.

The illustrated computer system 200 includes a processor 202 which controls the operation of the computer system 200, for example by executing an operating system (OS), device drivers, application programs, and so forth. The processor 202 can include any type of microprocessor or central processing unit (CPU), including programmable general-purpose or special-purpose microprocessors and/or any of a variety of proprietary or commercially available single or multi-processor systems. The computer system 200 also includes a memory 204, which provides temporary or permanent storage for code to be executed by the processor 202 or for data that is processed by the processor 202. The memory 204 can include read-only memory (ROM), flash memory, one or more varieties of random access memory (RAM), and/or a combination of memory technologies. The various elements of the computer system 200 are coupled to a bus system 206. The illustrated bus system 206 is an abstraction that represents any one or more separate physical busses, communication lines/interfaces, and/or multi-drop or point-to-point connections, connected by appropriate bridges, adapters, and/or controllers.

The computer system 200 also includes a network interface 208, an input/output (I/O) interface 210, a storage device 212, and a display controller 214. The network interface 208 enables the computer system 200 to communicate with remote devices (e.g., other computer systems) over a network. The I/O interface 210 facilitates communication between one or more input devices, one or more output devices, and the various other components of the computer system 200. The storage device 212 can include any conventional medium for storing data in a non-volatile and/or non-transient manner. The storage device 212 can thus hold data and/or instructions in a persistent state (i.e., the value is retained despite interruption of power to the computer system 200). The storage device 212 can include one or more hard disk drives, flash drives, USB drives, optical drives, various media disks or cards, and/or any combination thereof and can be directly connected to the other components of the computer system 200 or remotely connected thereto, such as over a network. The display controller 214 includes a video processor and a video memory, and generates images to be displayed on one or more displays in accordance with instructions received from the processor 202.

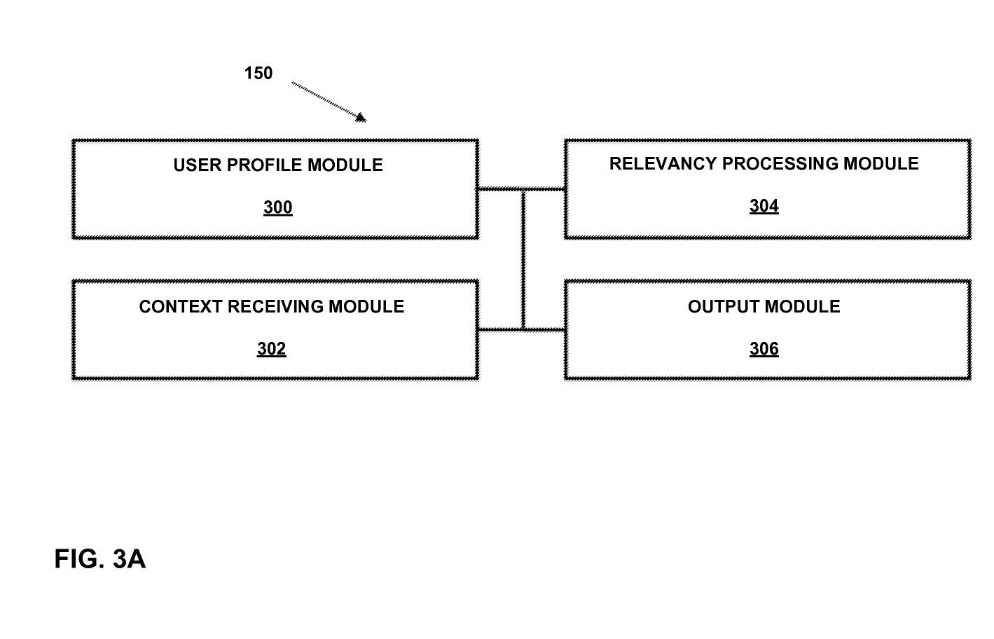

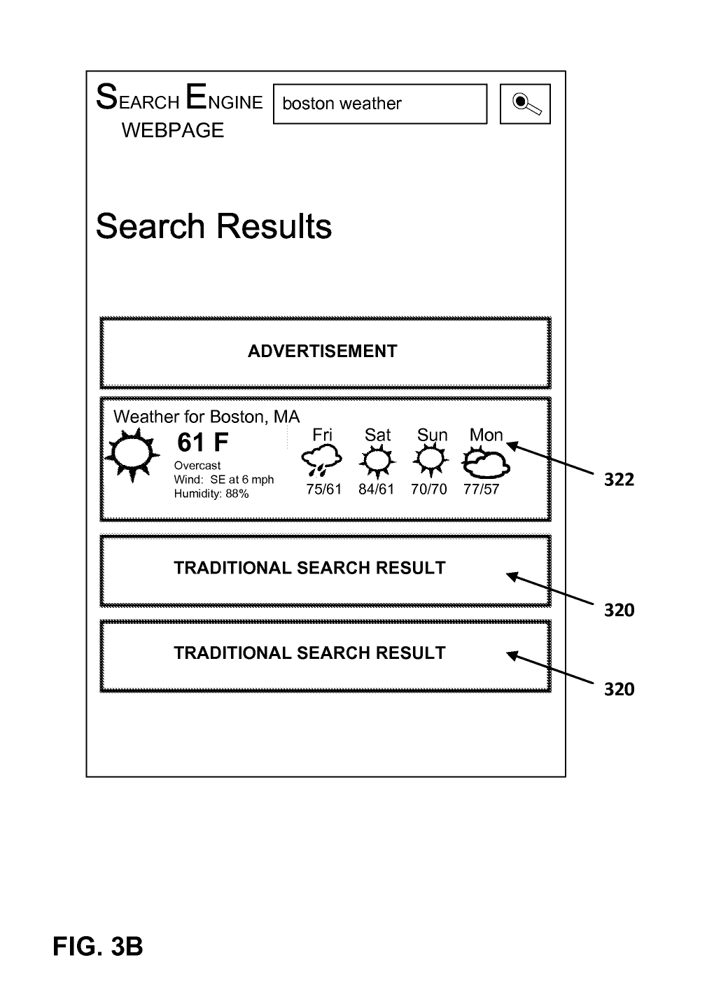

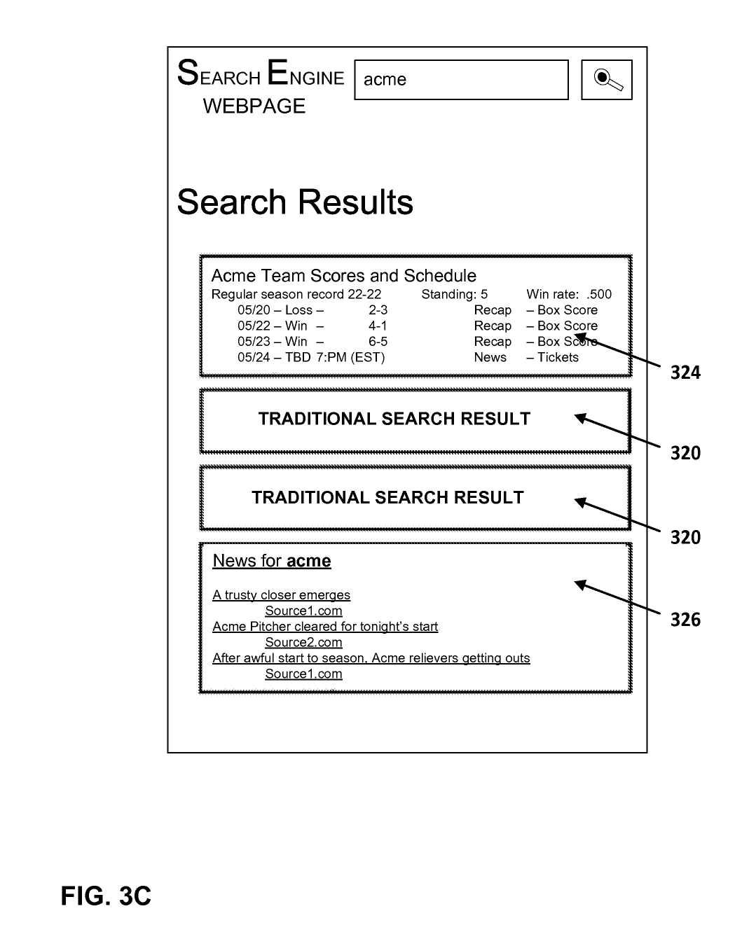

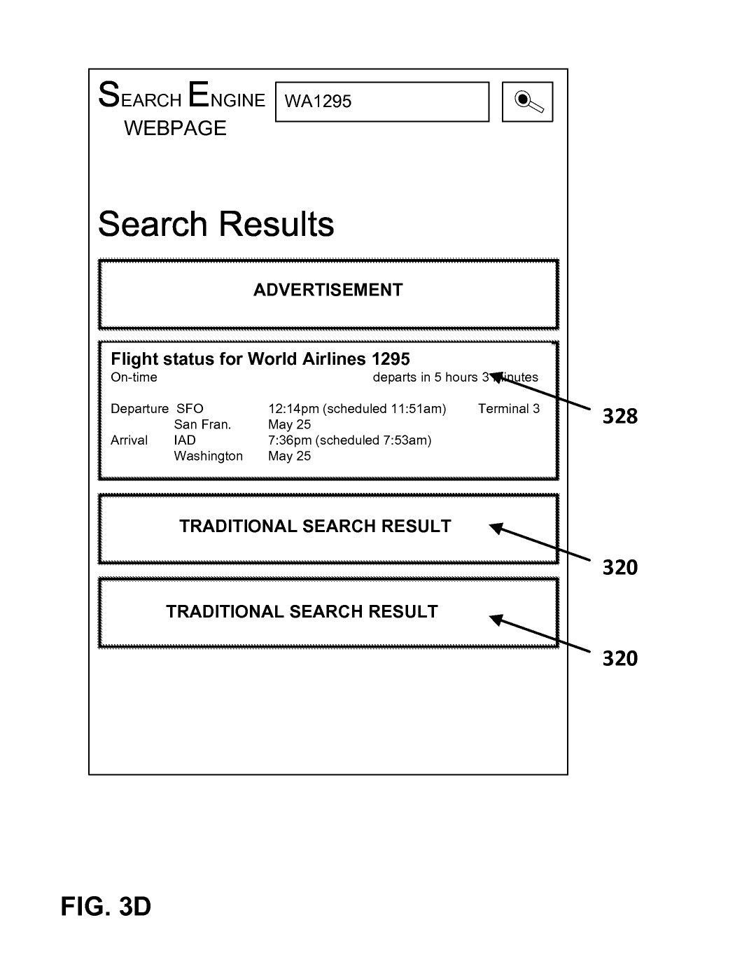

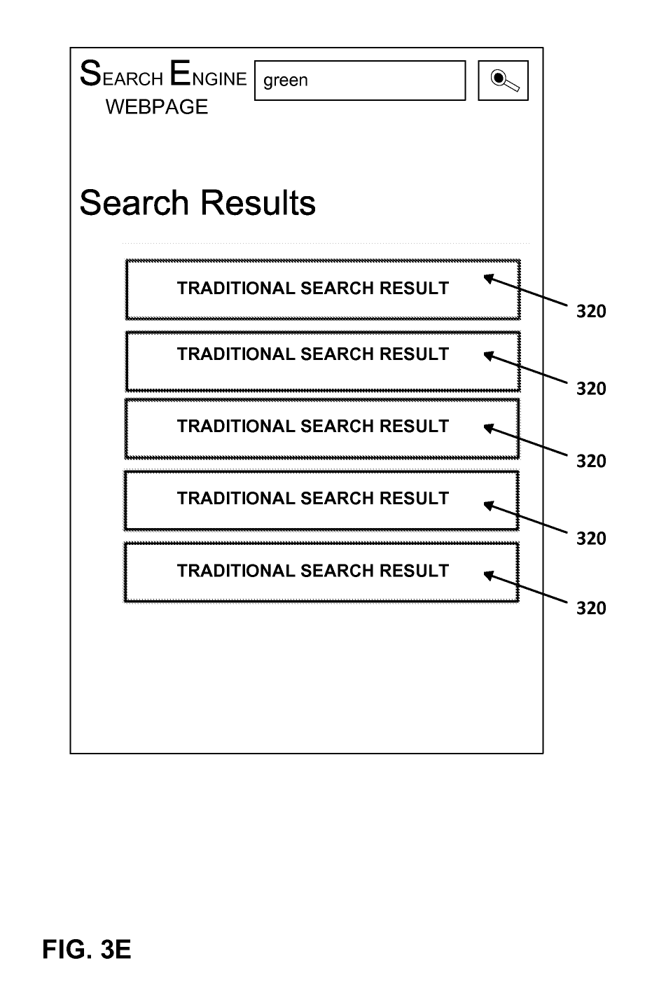

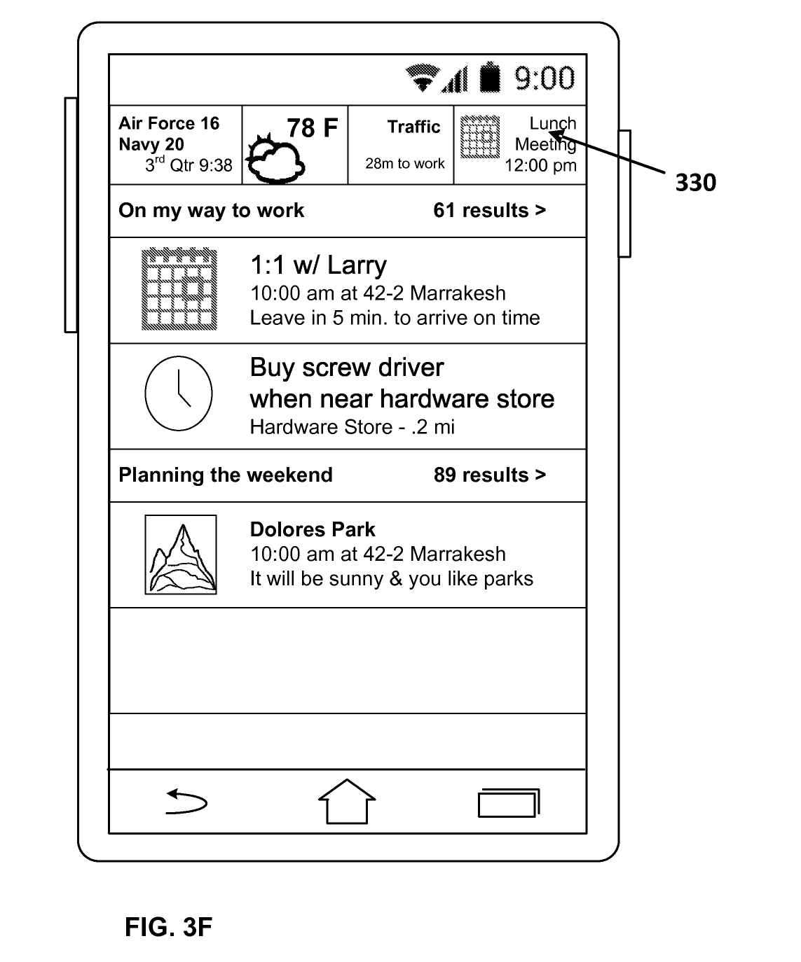

FIG. 3A is a schematic diagram of an example query server 150. The various functions performed by the query server 150 or the mobile device 120 can be logically described as being performed by one or more modules. It will be appreciated that such modules can be implemented in hardware, software, or a combination thereof. It will further be appreciated that, when implemented in software, modules can be part of a single program or one or more separate programs, and can be implemented in a variety of contexts (e.g., as part of an operating system, a device driver, a standalone application, and/or combinations thereof). In addition, software embodying one or more modules can be stored as an executable program on one or more non-transitory computer-readable storage mediums. Functions disclosed herein as being performed by a particular module can also be performed by any other module or combination of modules, and the query server 150 or the mobile device 120 can include fewer or more modules than what is shown and described herein. FIG. 3A is a schematic diagram of the modules of one example of the query server 150.

In situations discussed below in which the different modules, systems, and devices collect or make use of personal information about the user (e.g., search histories, location, etc.), the user may be provided with an opportunity to control whether the modules, systems, and devices can collect user information or to control whether and/or how to the modules, systems, and devices may receive content that may be relevant to the user. In addition, certain data may be treated in one or more ways before it is stored or used by the modules, systems, and devices, so that personally identifiable information is removed. Thus, the user may have control over how information (e.g., data) is collected about the user and used by the modules, systems, and devices described herein.

As shown in FIG. 3A, the query server 150 can include a user profile module 300 configured to maintain, for each user of the query server 150, a list of user interest queries representative of the user's interests. As used herein, a user interest query is a query entered by a user in a search engine for which the query server determines the user would like to receive updates, particularly if the results of the query have changed since last presented to the user.

The list of user interest queries associated with a particular user can be obtained in a variety of ways. In some examples, the user profile module 300 can be configured to communicate with a database in which the user's Internet search history is stored, and can infer or identify user interest queries from the search history.

The search history can include one or more queries as entered by the user. The search history can also include attribute information associated with each query. For example, the search history can include the time at which the query was executed, a flag indicating whether the query generated an inline search result (described in detail below), and/or an identifier that indicates the physical device from which the user entered the query.

The database can be stored on the mobile device 120, on the query server 150, and/or in other locations, such as a cloud-based repository. In accordance with published privacy policies, the database can be updated each time the user initiates an Internet search to store the search query entered by the user as an element in the user's search history. The database can store all of the user's searches, only searches that occurred during a predetermined time period (e.g., the last 24 hours, the last 7 days, the last 30 days, the last year, or since the user last cleared their search history), or any other subset of the user's searches. A search can be associated with a particular user, and thereby added to the user's search history, if it is executed on a device associated with the user, or if the user identifies him/herself at the time of initiating the search (e.g., by supplying a username and password or other login credentials). Accordingly, a user's search history can include elements from a plurality of devices (e.g., searches conducted by the user on their desktop computer as well as searches conducted by the user on their phone).

Once the user's search history is obtained, the user profile module can identify queries within the search history that are likely indicative of the user's interests. In some examples, the user profile module 300 can identify queries that generate inline search results as user interest queries.

As used in this specification, an inline search result is information returned by a search engine in response to a query without requiring the user to click, select, or otherwise traverse to a different web page, other than traditional search results that include a link to a web page and a short quote from the web page. A number of publicly accessible search engines may provide inline search results in response to certain queries.

FIG. 3B is a schematic diagram of a search result web page that includes a weather inline search result. For example, as shown in FIG. 3B, a search executed using a search engine for the query “boston weather” can return a number of traditional search results 320, as well as an inline search result 322 showing the current weather and the weather forecast for Boston, Mass. As another example, FIG. 3C is a schematic diagram of a search result web page that includes a sports team inline search result and a news inline search result. As shown in FIG. 3C, a search executed using the search engine for the query “acme” can return several traditional search results 320, as well as two inline search results 324, 326. A first inline search result 324 shows information relating to a sports team, such as the team record, division standing, scores of recent games, and schedule of upcoming games. A second inline search result 326 shows news stories relating to the sports team. By way of further example, FIG. 3D is a schematic diagram of a search result web page that includes a flight status inline search result. As shown in FIG. 3D, a search executed using the search engine for the query “WA1295” can return a number of traditional search results 320 and an inline search result 328. As shown, the inline search result 328 includes various information relating to WORLD AIRLINES flight 1295, such as the flight status, departure and arrival cities and times, and the time remaining until departure. In contrast, FIG. 3E is a schematic diagram of a search result web page that includes only traditional search results. As shown in FIG. 3E, some search queries can return only traditional search results (i.e., without returning any inline search results). As shown, a search executed using the search engine for the query “green” can return only traditional search results 320.

It will be appreciated that inline search results can be of various types or categories and can be generated in response to a variety of queries. Inline search result categories can include music results, movie show time results, news article results, stock quote results, weather results, flight status results, travel booking results, maps results, local business results, image results, product or shopping results, job posting results, classified ad results, scholarly article results, news archive results, group message board results, blog post results, user search history results, dictionary results, patent search results, phonebook results, calculator results, unit or currency conversion results, package tracking results, and so forth. In some examples, query server 150 may determine when to return inline search results, may generate inline search results, and/or may cause mobile device 120 to display inline search results using techniques employed by Internet search engines.

When a user executes a query that generates an inline search result, the query can be stored in the user's search history with a flag indicating that an inline search result was generated. The user profile module 300 can identify any query for which an “inline search generated” flag is set as a user interest query, and can store the user interest query in association with the user.

While queries that generate inline search results are used in some examples, other criteria for identifying user interest queries can be used instead or in addition thereto. For example, the user profile module 300 can identify queries that appear a plurality of times in the search history, that appear recently in the search history (e.g., within the last 24 or 48 hours), or that appear frequently in the search history (e.g., at least once per week) as user interest queries. A user can also specify that a particular query is of interest to the user at the time the query is entered (e.g., by checking a box or actuating some other user interface element, or by including a predefined operator in the search string itself). In some examples, all queries in the user's search history can be identified as user interest queries. This example may be over-inclusive, however, in that it may not accurately reflect the user's true interests. Accordingly, limiting the user interest queries (e.g., to those that generated inline search results or appear frequently in the user's search history) can more-accurately specify the user's interests, in some examples.

The user profile module 300 can also be configured to categorize user interest queries as either timely interests or ongoing interests. For example, a timely interest, such as the status of a flight or the status of a tracked package, is only of interest for a limited time (e.g., until the flight lands or the package is delivered), after which they are no longer of interest to the user. On the other hand, some interests such as a particular sports team are ongoing interests that are unlikely to expire in the foreseeable future.

To identify timely interests, the user profile module 300 can review the last N hours of the user's search history. Values for N include 6 hours, 12 hours, 24 hours, 36 hours, 48 hours, 72 hours, 168 hours, and so forth. Any queries in this portion of the user's search history that relate to a particular expiration date or time can be identified as timely user interest queries. Upon lapse of the expiration date or time associated with a particularly query, optionally with a predetermined post-expiration delay, the user profile module 300 can be configured to no longer identify the query as a user interest query. Thus, when a user searches for the status of a flight, the query can be identified as a user interest query only up until the time the flight lands or shortly thereafter (e.g., after a predetermined delay lapses). In the case of timely interests, a single query executed by the user during the last N hours of search history can be sufficiently frequent for the query to be identified by the user profile module 300 as a user interest query.

To identify ongoing interests, the user profile module 300 can review the entirety of the user's search history, searching for queries that are repeated, or queries that are repeated over a lengthy time period (e.g., repeated several times on different days or different weeks). For example, the user profile module 300 can be configured such that a user must execute a query on at least five different days before it is identified as an ongoing user interest query. The user profile module 300 can continuously update the list of user interest queries associated with a particular user, or can be configured to run periodic updates (e.g., every night).

The query server 150 can also include a context receiving module 302 configured to receive the user's context. The user's context can include location data indicative of the current location of the user. The user's context can also include the local time at the user's current location, which can be received with the location data, or calculated or obtained by the context receiving module 302 based on the location data. In situations described herein, in which context receiving module 302 can collect or make use of personal information about the user (e.g., the user's context) the user may be provided with an opportunity to control whether the programs or features of context receiving module 302 can collect user information or to control whether and/or how to context receiving module 302 may receive content that may be relevant to the user. In addition, certain data may be treated in one or more ways before it is stored or used by context receiving module 302 so that personally identifiable information is removed. Thus, the user may have control over how information (e.g., data) about the user's context is collected and used by context receiving module 302.

In some instances, the current location of a user can be inferred from the current location of a mobile device or other object in the user's possession. In the example shown in FIG. 1, the mobile device 120 can be configured to periodically communicate its current location to the context receiving module 302 using the mobile network 100. This can occur several times per minute, once per minute, once per hour, or at any other regular or sporadic time interval. The mobile device 120 can determine or estimate its current location using any of a variety of known techniques, such as by processing GPS signals, by detecting proximity to cell towers, Wi-Fi hot spots, or other mobile access points 130 of known location, or by triangulating between the mobile device 120 and a plurality of such access points 130. One example of a computer program for obtaining a user's current location may provide the best estimate of a user's location using a number of onboard or server-based sources (called location providers).

The context receiving module 302 can also receive the user's current location from other sources, such as when a user “checks in” at a location using any of a number of social applications that provide for such check-ins, when the user indicates their current position by dropping a pin at a particular location or making an equivalent selection using mapping software or when the user responds to a prompt for their current position. It will be appreciated that the location data received by the context receiving module 302 need not necessarily be indicative of the user's current location or current time. Rather, the user can also provide some other location or time, such as some future time or a location that the user has visited in the past or plans to visit in the future, in order to obtain query results or other information relevant to that location or time.

The location data received by the context receiving module 302 can be arranged in a format that includes a longitude, a latitude, and an accuracy radius. The accuracy radius can represent an estimate of the accuracy of the current location data. The accuracy radius can range from meters to kilometers depending on the source of the location data. For example, location data derived from GPS signals can have an accuracy radius of several meters while location data derived from triangulation of cell towers can have an accuracy radius of several kilometers. The context receiving module 302 can also receive raw proximity or other data from the mobile device 120 and can perform any necessary triangulation or location calculations on the server side.

The query server 150 can also include a relevancy processing module 304 configured to determine whether any of the user interest queries stored in association with a user are relevant based on the user context received by the context receiving module 302, or based on the user profile maintained by the user profile module 300. Any of a variety of techniques or algorithms can be used to make this determination.

In some examples, the relevancy processing module 304 can determine that a user interest query is relevant when the results of the query have changed since the query results were last output to the user. This can be particularly suitable for ongoing user interests. For example, the relevancy processing module 304 can consider a score change in a game in which the user's favorite baseball team is playing to be relevant.

In some examples, the relevancy processing module 304 can determine that a user interest query is relevant when the query is identified as relating to a time or event that occurs in the near future. In such examples, the relevancy processing module 304 can determine the temporal proximity between the user's current time and the upcoming time associated with the user interest query. If the time difference is below a predetermined threshold (e.g., less than 24 hours away, less than 12 hours away, less than 6 hours away, less than 2 hours away, less than 1 hour away, etc.), the user interest query can be determined to be relevant. This can be particularly suitable for timely user interests. For example, the relevancy processing module 304 can consider a flight status to be relevant up until the time the flight lands, even if the flight status has not changed since it was last presented to the user.

In some examples, the relevancy processing module 304 can determine that a user interest query is relevant when the query relates to a geographical location proximate to the user's current location. For example, if the user's context indicates that the user is near a particular destination city and the user's profile includes one or more user interest queries associated with that city, those queries can be considered relevant by the relevancy processing module 304.

In some examples, the relevancy processing module 304 can determine that a user interest query is relevant when the query relates to a particular time of day or day of the week that matches the user's current time. For example, if the user searches for traffic information for their commute to work every weekday morning, the relevancy processing module 304 can consider such a traffic query to be relevant whenever the user's context indicates that the user's local time is during a weekday morning. In this manner, the traffic query can be automatically updated and presented to the user without requiring the user to manually perform the query. On the other hand, when the user's context indicates that the user's local time is not during a weekday morning, the traffic query will not be considered relevant by the relevancy processing module 304 and therefore the user will not be presented with non-relevant information. The relevancy processing module 304 can thus make a determination as to whether a user interest query is relevant based on the user's context and/or the user's profile.

The query server 150 can also include an output module 306 configured to generate a notification or other output based on determinations made by the relevancy processing module 304. For example, the output module 306 can send a text message, email, or push notification to the user's mobile device that includes the results of a user interest query. By way of further example, the output module 306 can output an instruction that instructs the user's mobile device to display an option or a prompt to the user. The option or prompt can allow the user to indicate that a user interest query is not actually of interest to the user, or that a user interest query is of interest to the user but is not relevant to the user's context. Feedback provided by the user in this way can be used by the relevancy processing module 304 in making future relevancy determinations, thereby improving system accuracy. Outputs generated by the output module 306 can be sent as data transmissions via the mobile network 100 to the mobile device 120, which can in turn be configured to display or otherwise present the output to the user. The presentation to the user can be in a standalone application, a device home screen, a native application, or in any other program executed on the mobile device. For example, FIG. 3F is a diagram of a graphical user interface that can be displayed on a mobile device. As shown in FIG. 3F, outputs generated by the output module 306 can be displayed in an information bar 330 within a mobile application executed on the user's mobile device 120. Updated query results provided automatically by the query server 150 are shown, such as the current traffic on the user's commute to work and the score of a football game in which one of the user's favorite teams is playing.

The output module 306 can also be configured to push alerts to the user's mobile device. For example, if the system determines that the user follows a particular sports team, the output module 304 can notify the user via an alarm or buzzer when that team is playing and the score changes, or if the user is interested in the status of a flight, the system can notify the user if the expected departure or arrival time changes.

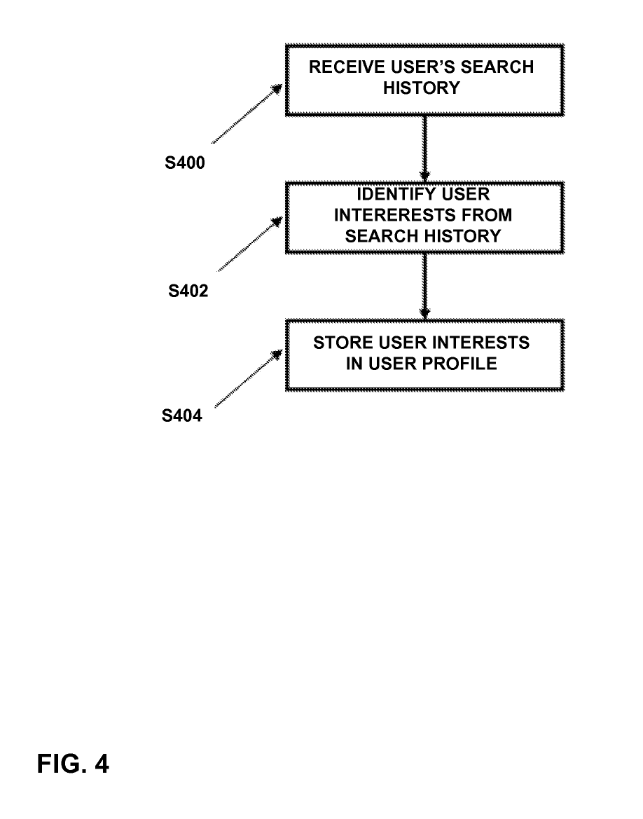

FIG. 4 is a flowchart that schematically depicts example operations for maintaining a user profile. While various operations disclosed herein may be shown in relation to a flowchart or flowcharts, it should be noted that any ordering of steps implied by such flowcharts or the description thereof is not to be construed as limiting the operations to performing the steps in that order. Rather, the various steps of each of the operations disclosed herein can be performed in any of a variety of sequences. In addition, as the illustrated flowchart(s) are merely examples, various other examples that include additional steps or include fewer steps than illustrated are also within the scope of the described techniques. In addition, the various operations described with respect to FIG. 4 can be performed by a computing device, such as query server 150 and mobile device 120, and/or one or more modules of the computing device, such as user profile module 300 and context receiving module 302.

The illustrated operations, which, in some examples, can be executed by a computing device, such as the query server 150, begin at step S400 where a user's search history is received by the user profile module 300. At step S402, the user profile module 300 identifies user interests from the search history received in step S400. In particular, the user profile module 300 can identify one or more user interest queries from the search history, such as queries that triggered display of an inline search result when last executed. At step S404, user interests (e.g., user interest queries) are stored in association with the user. The stored profile can be accessed later by other aspects of the system to retrieve the user's interests.

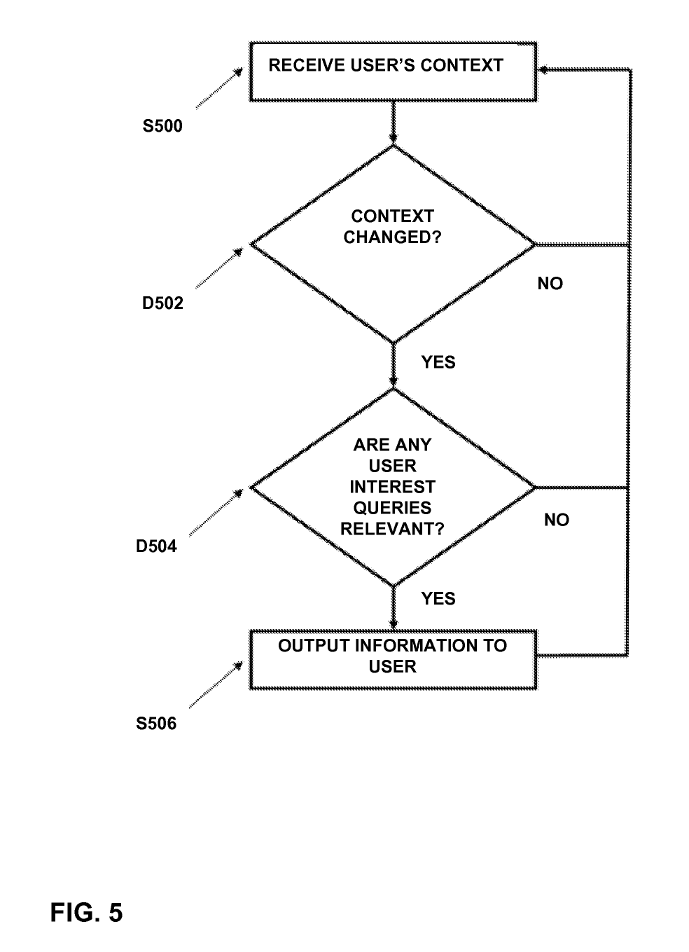

FIG. 5 is a flowchart that schematically depicts example operations for automatically updating a query on behalf of a user. The various operations described with respect to FIG. 5 can be performed by a computing device, such as query server 150 and mobile device 120, and/or one or more modules of the computing device, such as user profile module 300 and context receiving module 302. At step S500, a user's context is received by the context receiving module 302. As noted above, the user's context can include location data indicative of the current location of the user or some other location specified by the user, as well as the local time at the user's current location.

At decision block D502, it is determined whether the user's context has changed since the last time the operations were executed. If no change is detected (“NO” in decision block D502), execution returns to step S500 and the process repeats. The decision as to whether a change in location has occurred can be made based on the degree to a which a user's location has changed, such that movement of the user a short distance is not flagged as a location change, and only changes in location that exceed a predetermined distance threshold (e.g., 0.1 miles, 0.5 miles, 1 mile, 10 miles, etc.) are flagged. The decision as to whether a change in time has occurred can be made based on the degree to a which the user's local time has changed, such that the operations are only executed when an amount of time has passed that exceeds a predetermined time threshold (e.g., 1 second, 1 minute, 10 minutes, 1 hour, etc.).

In some examples, the user's context can be received with a request for updated query results relevant to that context. For example, the user's mobile device can periodically or intermittently send requests to the query server 150, which can be accompanied by location or time data. Such requests can be sent automatically by the user's mobile device, without requiring action by the user.

When a change in context is detected and/or when a request for updated query results is received (“YES” in decision block D502), execution proceeds to decision block D504. In decision block D504, the relevancy processing module 304 can make a determination as to whether any of the user interest queries stored for the user are relevant based on the user's context and/or the user's profile.

When none of the user interest queries are determined to be relevant (“NO” in decision block D504), execution returns to step S500 and the process repeats. When a user interest query is determined to be relevant (“YES” in decision block D504), execution proceeds to step S506.

In step S506, information relating to user interest queries that are determined to be relevant, such as one or more updated results of said queries, can be output by the output module 306 for presentation to the user. In particular, the information can be sent to the user's mobile device as a text message, email, or other notification. Execution can then return to step S500 and the process repeats. Accordingly, using the described techniques, a user can be automatically provided with updated query results based on their user interest profile and their current context.

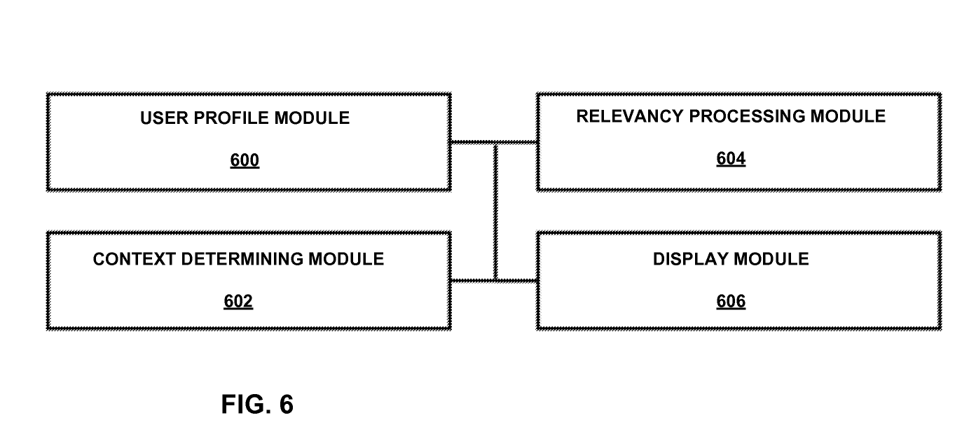

In some examples, some or all of the functionality disclosed above as being performed by the query server 150 can instead be performed by the mobile device 120. FIG. 6 is a schematic diagram of the modules of an example mobile device. The structure and function of the mobile device illustrated in FIG. 6 is substantially similar to that of the query server of FIG. 3A, except as noted herein and as will be readily apparent to those having ordinary skill in the art. Accordingly, a detailed description thereof is omitted here for the sake of brevity.

As shown in FIG. 6, the mobile device can include a context determining module 602 configured to estimate the current location of the mobile device, for example using GPS or access point triangulation. The mobile device can also include a display module 606 configured to display information relating to user interest queries determined to be relevant to the user's context. The other illustrated modules can function in the same manner as those disclosed above with respect to the query server 150, except that data stored or produced by a remote server (e.g., the results of a query) can be accessed by those modules using one or more calls to the remote server, for example using the mobile network 100.

In some examples, a computing system may determine a search history of a user of a computing device. The search history may include a plurality of queries associated with the user. The computing system may identify at least one query from the plurality of queries as a user interest query and may receive, from the computing device, contextual information of the computing device, and may determine, based on the contextual information, a current context of the user. Responsive to determining that the user interest query is relevant to the current context of the user, the computing system may send to the computing device, an updated result of the user interest query.

In some examples, the computing system may identify the at least one query from the plurality of queries as the user interest query in response to determining that the at least one of the plurality of queries is associated with a previously triggered inline search result. In some examples, the computing system may identify the at least one query from the plurality of queries as the user interest query in response to determining that the at least one query is a duplicate of a query from the plurality of queries. In some examples, the computing system may identify the at least one query from the plurality of queries as the user interest query in response to determining that the duplicate is an ongoing user interest query associated with more than one time of day.

In some examples, responsive to determining that the user interest query is associated with an expiration time, the computing system may determine that the user interest query is a time-sensitive user interest query, and responsive to determining that a current time associated with the computing device is prior to the expiration time, the computing system may send, to the computing device, the time-sensitive user interest query. In some examples, the current context of the user may include a current location of the user and a local time at the current location.

In some examples, the computing system may determine that the user interest query is relevant to the current context of the user by determining that a current result of the user interest query is different from a previously outputted result of the user interest query. In some examples, the computing system may determine that the user interest query is relevant to the current context of the user by determining that an event associated with the user interest query is scheduled to occur within a predetermined amount of time from a local time at a current location of the user. In some examples, the computing system may determine that the user interest query is relevant to the current context of the user by determining that an event associated with the user interest query is scheduled to occur within a predetermined distance from a current location of the user.

In some examples, the computing system may receive, from the computing device, a request for relevant information based on the current context of the user. Responsive to receiving the request, the computing system may output, to the computing device, the updated result of the user interest query.

In some examples, a computing device may receive, an indication of a query associated with a user of the computing device, may send, to a computing system, the query, may receive, from the computing system, a first result of the query, and may output, for display, an indication of the first result. The computing device may send, to the computing system, contextual information of the computing device, and receive, from the computing system, an updated result of the query. The updated result of the query may include information that is more relevant to the contextual information than the initial result of the query. Responsive to receiving an indication of an input that corresponds to a command to display updated information, the computing system may output, for display, an indication of the updated result. In some examples, the updated result of the query may be different from the first result of the query.

In some examples, the contextual information may include a first location associated with the computing device and the updated result of the query may be a first updated result of the query. Responsive to sending a second location associated with the computing device to the computing system, the computing device may receive, from the computing system, a second updated result of the query and output, for display, an indication of the second updated result.

In some examples, the computing device may send, to the computing system, profile information associated with the user. The profile information may include a search history associated with the user and the search history may include at least one instance of the query. Responsive to sending the profile information, the computing device may receive, from the computing system, the updated result of the query.

In some examples, the computing device may update a query on behalf of a user. The computing device may updating a query on behalf of a user by retrieving a user's Internet search history from a memory, said search history comprising a plurality of queries previously entered by the user, using a processor coupled to the memory, identifying at least one of the plurality of queries as a user interest query, and receiving a current context of the user. The operations may further include using the processor, determining whether the user interest query is relevant to the user based on the user's context, and using the processor, automatically outputting an updated result of the user interest query when the user interest query is determined to be relevant.

In some examples, the operations may include identifying a query as a user interest query by identifying if the query triggered an inline search result when the query was previously executed. In some examples, the operations may include identifying a query as a user interest query by identifying if the query appears multiple times in the user's search history. In some examples, the operations may include identifying a query as a user interest query by identifying a query that appears multiple times in the user's search history as an ongoing user interest query. In some examples, the operations may further include outputting results of the ongoing user interest query when updated results are available for said query.

In some examples, the operations may include identifying a query as a user interest query by identifying a query as a time-sensitive user interest query when the query is associated with an expiration time. In some examples, the operations may further include automatically outputting results of the time-sensitive user interest query until the expiration time lapses. In some examples, the user's context may include the user's current location and the local time at the user's current location.

In some examples, the operations for determining whether the user interest query is relevant to the user based on the user's context may include determining that the user interest query is relevant if a current result of the user interest query has changed since a previous result of the user interest query was output. In some examples, the operations for determining whether the user interest query is relevant to the user based on the user's context may include determining that the user interest query is relevant if the query relates to an event that is scheduled to occur within a predetermined time from a current time of the user.

In some examples, the operations for automatically outputting an updated result of the user interest query when the user interest query is determined to be relevant may include sending the updated result to a mobile device of the user. In some examples, the operations for automatically outputting an updated result of the user interest query when the user interest query is determined to be relevant may include outputting the updated result in response to a request for relevant information received with the user's context.

Although the various techniques have been described by reference to specific examples, it should be understood that numerous changes may be made within the spirit and scope of the inventive concepts described. Accordingly, it is intended that the described techniques are not limited to the described examples, but that the described techniques have the full scope defined by the language of the following claims.

What is claimed is:

1. A method comprising:
determining, by a computing system, a search history of a user of a computing device, the search history including a plurality of queries associated with the user;
identifying, by the computing system, at least one query from the plurality of queries as a user interest query;
receiving, by the computing system, from the computing device, contextual information of the computing device;
determining, by the computing system, based on the contextual information, a current context of the user; and
responsive to determining that the user interest query is relevant to the current context of the user and responsive to determining that an updated result of the user interest query is different from a previous result of the user interest query, sending, by the computing system, to the computing device, the updated result of the user interest query.

2. The method of claim 1, wherein the at least one of the plurality of queries is associated with an inline search result.

3. The method of claim 1, wherein the at least one query is a duplicate of a query from the plurality of queries.

4. The method of claim 3, wherein the duplicate is an ongoing user interest query associated with more than one time of day.

5. The method of claim 1, further comprising:
responsive to determining that the user interest query is associated with an expiration time, determining, by the computing system, that the user interest query is a time-sensitive user interest query; and
responsive to determining that a current time associated with the computing device is prior to the expiration time, sending, by the computing system, to the computing device, the time-sensitive user interest query.

6. The method of claim 1, wherein the current context of the user includes a current location of the user and a local time at the current location.

7. The method of claim 1, wherein determining that the user interest query is relevant to the current context of the user includes determining, by the computing system, that an event associated with the user interest query is scheduled to occur within a predetermined amount of time from a local time at a current location of the user.

8. The method of claim 1, wherein determining that the user interest query is relevant to the current context of the user includes determining, by the computing system, that an event associated with the user interest query is scheduled to occur within a predetermined distance from a current location of the user.

9. The method of claim 1, further comprising:
receiving, by the computing system, from the computing device, a request for relevant information based on the current context of the user; and
responsive to receiving the request, outputting, by the computing system, to the computing device, the updated result of the user interest query.

10. A method comprising:
receiving, by a computing device, an indication of a query associated with a user of the computing device;
sending, by the computing device, to a computing system, the query;
receiving, by the computing device, from the computing system, a first result of the query;
outputting, by the computing device and for display, an indication of the first result;
sending, by the computing device, to the computing system, contextual information of the computing device;
receiving, by the computing device, from the computing system, an updated result of the query, wherein the updated result of the query includes information that is more relevant to the contextual information than the initial result of the query; and
responsive to receiving an indication of an input that corresponds to a command to display updated information, outputting, by the computing device and for display, an indication of the updated result.

11. The method of claim 10, wherein the updated result of the query is different from the first result of the query.

12. The method of claim 10, wherein the contextual information includes a first location associated with the computing device, and the updated result of the query is a first updated result of the query, the method further comprising:
responsive to sending a second location associated with the computing device to the computing system, receiving, by the computing device, from the computing system, a second updated result of the query; and
outputting, by the computing device and for display, an indication of the second updated result.

13. The method of claim 10, further comprising:
sending, by the computing device, to the computing system, profile information associated with the user, wherein the profile information includes a search history associated with the user, the search history including at least one instance of the query; and
responsive to sending the profile information, receiving, by the computing device, from the computing system, the updated result of the query.

14. A computing system comprising:
at least one processor; and
at least one module operable by the at least one processor to:
determine a search history of a user of a computing device, the search history including a plurality of queries associated with the user;
identify at least one of the plurality of queries as a user interest query;
receive, from the computing device, contextual information of the computing device;
determine, based on the contextual information, a current context of the user; and
responsive to determining that the user interest query is relevant to the current context of the user and responsive to determining that an updated result of the user interest query is different from a previous result of the user interest query, send, to the computing device, the updated result of the user interest query.

15. The computing system of claim 14, wherein the at least one of the plurality of queries is associated with a previously triggered inline search result.

16. The computing system of claim 14, wherein the at least one query is a duplicate of a query from the plurality of queries.

17. The computing system of claim 16, wherein the duplicate is an ongoing user interest query associated with more than one time of day.

18. The computing system of claim 14, wherein the at least one module is further operable by the at least one processor to:
responsive to determining that the user interest query is associated with an expiration time, determine that the user interest query is a time-sensitive user interest query; and
responsive to determining that a current time associated with the computing device is prior to the expiration time, send, to the computing device, the time-sensitive user interest query.

19. The computing system of claim 14, wherein the at least one module is further operable by the at least one processor to determine that the user interest query is relevant to the current context of the user by at least determining that an event associated with the user interest query is scheduled to occur within a predetermined amount of time from a local time at a current location of the user.

20. The computing system of claim 14, wherein the at least one module is further operable by the at least one processor to determine that the user interest query is relevant to the current context of the user by at least determining that an event associated with the user interest query is scheduled to occur within a predetermined distance from a current location of the user.

21. The computing system of claim 14, wherein the at least one module is further operable by the at least one processor to:
receive, from the computing device, a request for relevant information based on the current context of the user; and
responsive to receiving the request, output, to the computing device, the updated result of the user interest query.

22. A computing device comprising:
an input device;
a display device;
at least one processor; and
at least one module operable by the at least one processor to:
receive, at the input device, an indication of a query associated with a user of the computing device;
send, to a computing system, the query;
receive, from the computing system, a first result of the query;
output, for display at the display device, an indication of the first result;
send, to the computing system, contextual information of the computing device;
receive, from the computing system, an updated result of the query, wherein the updated result of the query includes information that is more relevant to the contextual information than the initial result of the query; and
responsive to receiving an indication of an input that corresponds to a command to display updated information, output, for display, an indication of the updated result.
